(19) United States
(12) Patent Application Publication
(10) Pub. No.: US 2016/0117920 A1
(43) Pub. Date: Apr. 28, 2016

(54) METHOD FOR RETRANSMISSION OF INFARED REMOTE CONTROL SIGNALS, AND REMOTE CONTROL SIGNAL TRANSPONDER

(71) Applicant: Quatius Limited, Kowloon (HK)

(72) Inventor: Huiquan LIN, Kowloon (HK)

(21) Appl. No.: 14/919,470

(22) Filed: Oct. 21, 2015

(30) Foreign Application Priority Data
Oct. 22, 2014 (CN) 201410566282.1

(51) Int. Cl. G08C 23/04

(52) U.S. Cl. CPC G08C 23/04; G08C 2201/40

(57) ABSTRACT

A method for retransmission of infrared remote control signals is disclosed, including acquiring key code values of a remote control of a second electrical appliance to be simulated and retransmitted by a first electrical appliance; creating a key code value table of remote control pulse signals of the second electrical appliance according to the key code values, and storing the key code value table in a server; downloading, by the first electrical appliance, the key code value table corresponding to the remote control of the second electrical appliance, from the server via a network; and receiving, by the first electrical appliance, key codes that input from the remote control for remotely controlling the second electrical appliance, converting the received key codes into corresponding remote control pulse signals according to the key code value table, and retransmitting the remote control pulse signals to a signal receiver of the second electrical appliance.

### CROSS REFERENCE TO RELATED APPLICATION

This application claims the priority benefit of Chinese Patent Application No. 201410566282.1, filed Oct. 22, 2014, the contents of which are incorporated by reference herein in their entirety for all purposes.

### FIELD OF THE INVENTION

The present invention generally relates to the technical field of electrical appliances, and more particularly, to a method for retransmission of infrared remote control signals and a remote control signal transponder.

### BACKGROUND

In the present household appliances, each device is generally equipped with a remote control. A user may often need to use a plurality of remote controls when, for example, using a television, a digital TV set top box and a video player at the same time. It is likely that frequent switching between the remote controls causes inconvenience for users.

At present, there are several kinds of universal remote controls in the market. For example, a universal remote control can learn and thus acquire the function of a TV remote control, such as the function of ON-OFF key and volume control key, etc., so as to achieve dual function in one remote control. Alternatively, a specialized learning type remote control is also available. These remote controls, however, has limited functionality and may lead to wasting for the idle of the original remote controls.

In addition, with the continuous development of intellectual technology, the technology of mobile phone universal remote control has appeared. Compared with the above-mentioned universal remote control, the difference is that the technology can realize the remote control function by installing corresponding software on a common intelligent terminal (for example, a mobile phone) and utilizing internal remote control codes to control substantially all of household appliances (such as television, set top box, air conditioner, etc) under the infrared remote control, and the technology also has the function of learning infrared remote control codes, network sharing and downloading. Although the technology of mobile phone universal remote control brings convenience to users, there is an obvious defect that the user must be equipped with an intelligent terminal which costs much, and corresponding software should be installed to carry out complex operations on the intelligent terminal. This may be inconvenient and affects the user experience.

### SUMMARY

In view of the problems existing in the prior art, it is an object of the present invention to provide a method for retransmission of infrared remote control signals, and a remote control signal transponder, which has low cost and is convenient for the user.

According to one aspect of the disclosure, a method for retransmission of infrared remote control signals includes the following steps:
acquiring key code values of a remote control of a second electrical appliance to be simulated and retransmitted by a first electrical appliance;
creating a key code value table of remote control pulse signals of the second electrical appliance according to the key code values, and storing the key code value table in a server;
downloading, by the first electrical appliance, the key code value table corresponding to the remote control of the second electrical appliance, from the server via a network; and
receiving, by the first electrical appliance, key codes that input from the remote control for remotely controlling the second electrical appliance, converting the received key codes into corresponding remote control pulse signals according to the key code value table, and retransmitting the remote control pulse signals to a signal receiver of the second electrical appliance.

In the above method for retransmission of infrared remote control signals, the key code value table of the remote control pulse signals of the second electrical appliance is acquired in advance. During use, the key code value table is downloaded by the first electrical appliance, and key codes that input into the remote control for remotely controlling the second electrical appliance is received by the first electrical appliance, and the received key codes is converted into the corresponding remote control pulse signals according to the downloaded key code value table to be retransmitted to the signal receiver of the second electrical appliance. When a first electrical appliance is set, the first electrical appliance and its remote control are used to simulate the key function of the infrared remote control of the second electrical appliance; and in this way, different electrical appliances can be controlled by one single remote control, without equipping other devices. This lowers the cost, simplifies the operation, avoids complicated operations like software installation, and improves the convenience of operation and enhances the user experience.

According to another aspect of the disclosure, a remote control signal transponder includes a power input circuit, a signal input interface, a front stage amplifier circuit, a final stage amplifier circuit, and an infrared diode array, wherein
the power input circuit is configured to connect with the front stage amplifier circuit and the final stage amplifier circuit respectively; the signal input interface, the front stage amplifier circuit, the final stage amplifier circuit and the infrared diode array are configured to be connected in turn; and
the power input circuit is configured to supply power to the front stage amplifier circuit and the final stage amplifier circuit; remote control pulse signals are input to the signal input interface, and are pre-amplified by the front stage amplifier circuit; the infrared diode array is driven by the final stage amplifier circuit to convert waveforms of the remote control pulse signals into infrared coded signals for transmission.

In the above remote control signal transponder, the remote control signal is amplified by the front stage amplifier circuit and the final stage amplifier circuit, and the final stage amplifier circuit drives the infrared diode array to convert waveforms of the remote control pulse signals into infrared coded signals for transmission, so it can simulate the function of transmission for infrared remote control very well.

### BRIEF DESCRIPTION OF THE DRAWINGS

The accompanying drawings illustrate one or more embodiments of the invention and together with the written description, serve to explain the principles of the disclosure. Wherever possible, the same reference numbers are used throughout the drawings to refer to the same or like elements of an embodiment.

FIG. 1 is a flow diagram showing a method for retransmission of infrared remote control signals in accordance with certain embodiments of the present invention;

FIG. 2 is a flow diagram showing a process for an intelligent television simulating other associated equipments in accordance with certain embodiments of the present invention;

FIG. 3 is a schematic diagram illustrating a remote control signal transponder in accordance with certain embodiments of the present invention;

FIG. 4 is a schematic diagram illustrating a power and signal input interface in accordance with certain embodiments of the present invention.

FIG. 5 is a schematic diagram illustrating a remote control signal transponder in accordance with a preferred embodiment of the present invention;

FIG. 6 is a schematic diagram illustrating a housing of a remote control signal transponder in accordance with certain embodiments of the present invention.

### DETAILED EMBODIMENTS

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

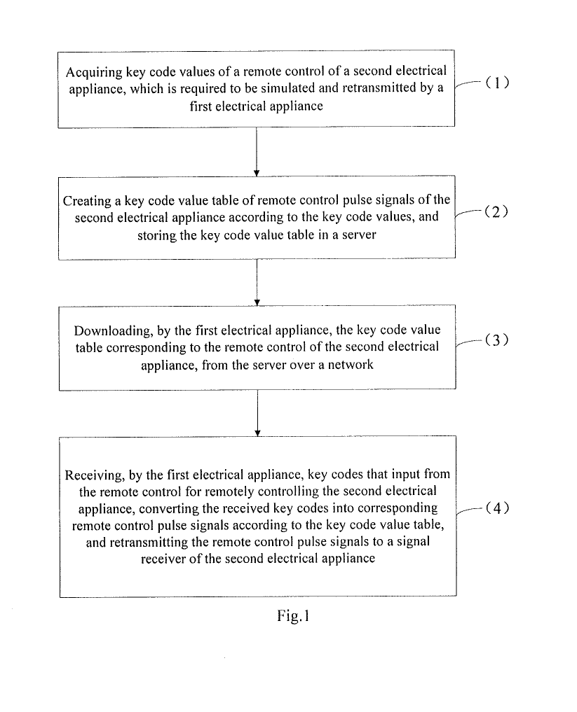

In one embodiment of the present disclosure, as shown in FIG. 1, a method for retransmission of infrared remote control signals includes the following steps.

Step (1) Acquire key code values of a remote control of a second electrical appliance to be simulated and retransmitted by a first electrical appliance.

Specifically, key code values of a remote control corresponding to a remote control of each new second electrical appliance can be extracted by an infrared signal analyzer. The first electrical appliance is used to implement the simulation process, that is, the key code values of the remote control of the second electrical appliance can be simulated by the first electrical appliance and a remote control of the first electrical appliance.

In a preferred embodiment, the second electrical appliance is an associated device used with the first electrical appliance. This will be convenient to use and to obtain a better user experience.

For example, the first electrical appliance may be an intelligent television, the second electrical appliance may be an associated device selected from the group consisting of set top box, video player and audio device. In this way, all of the associated devices, such as set top box, video player and audio device, can be remotely controlled by the remote control of the intelligent television.

Step (2) Create a key code value table of remote control pulse signals of the second electrical appliance according to the key code values, and store the key code value table in a server.

Specifically, the key code value table of the remote control of each of the various second electrical appliances can be stored in a database of the server, so that the first electrical appliance can download and use the key code value table.

Step (3) Download, by the first electrical appliance, the key code value table corresponding to the remote control of the second electrical appliance, from the server via a network.

In this step, the first electrical appliance may be connected to the network and download the key code value table corresponding to the type of the of the remote control of the second electrical appliance from the server, according to the type of the remote control of the second electrical appliance to be simulated by the first electrical appliance.

Before the step (3), an option of retransmitting the infrared remote control signals to the second electrical appliance may be provided in the operating system of the first electrical appliance to form a function interface of remote control which is added to the control program of the first electrical appliance. In this way, it is free for the user to selectively enter into the control flow of the second electrical appliance via the option in the operating system of the first electrical appliance.

Step (4) Receive, by the first electrical appliance, key codes that input from the remote control for remotely controlling the second electrical appliance, convert the received key codes into corresponding remote control pulse signals according to the key code value table, and retransmit the remote control pulse signals to a signal receiver of the second electrical appliance.

In this step, the user can enter the key codes for remotely controlling the second electrical appliance via the remote control of the first electrical appliance; the first electrical appliance receives the key codes input from the remote control and converts the received key codes into corresponding remote control pulse signals, which is equivalent to simulating the function of remote control of the second electrical appliance. Then, the first electrical appliance retransmits the remote control pulse signals to the signal receiver of the second electrical appliance; as a result, the second electrical appliance can be remotely controlled by the first electrical appliance.

In this example, more key functions can be simulated by the first electrical appliance, so that the first electrical appliance and the second electrical appliance can use one same remote control.

For example, with the own remote control of the intelligent television, the key functions of the remote control of the associated devices, such as set top box, video player and audio device, can be simulated in the intelligent television. This solution facilitates application of these electrical appliances for users. Meanwhile, this solution allows users to maintain their usage habits for the remote control of the intelligent television, without having to add additional an intelligent terminal, and also without having to carry out complex operations, such as software installation, significantly improving the user experience.

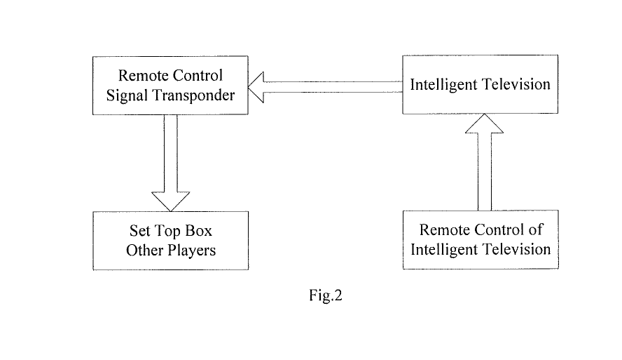

As discussed above, in one embodiment, the remote control of the intelligent television in the technical solution of the present invention can implement the infrared remote control of all of the associated devices used with the intelligent television, for example, set top box, video player and audio device. In the implementation process of the technical solution, the function of the main chip of the intelligent television can be used to execute the stored software program to realize the simulation of the remote control pulse signals. The simulated remote control pulse signals can be retransmitted to the signal receiver of the second electrical appliance via the remote control signal transponder coupled to the interface for retransmission of infrared remote control signals in the intelligent television. As shown in FIG. 2, it is an illustration of the control flow for an intelligent television simulating other associated devices.

The technical solution of the embodiment can fully utilize the function of the main ship of the intelligent television to implement the simulation of the remote control for code signal output, in combined with software.

In a preferred embodiment, control interfaces for other associated devices may be provided in the operating system of the intelligent television. For example, the control interfaces for set top box, video player and audio device can be added to the control interface of the intelligent television that the user can perform remote control following the guidelines in the control interface, to further improve the user experience.

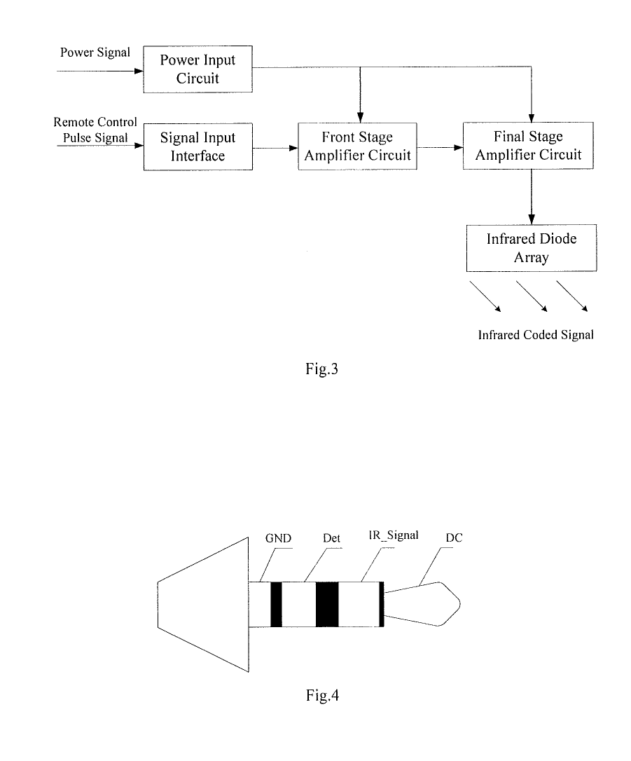

In one embodiment of the present invention, a remote control signal transponder is provided to retransmit the remote control pulse signals described above, for the method for retransmission of infrared remote control signals according to the present invention. As shown in FIG. 3, it illustrates a structure of a remote control signal transponder, and the remote control signal transponder includes a power input circuit, a signal input interface, a front stage amplifier circuit, a final stage amplifier circuit, and an infrared diode array.

The power input circuit is connected with the front stage amplifier circuit and the final stage amplifier circuit respectively, and the signal input interface, the front stage amplifier circuit, the final stage amplifier circuit and the infrared diode array are connected in turn.

The power input circuit supplies power to the front stage amplifier circuit and the final stage amplifier circuit; remote control pulse signals are input to the signal input interface, and are pre-amplified by the front stage amplifier circuit; the infrared diode array is driven by the final stage amplifier circuit to convert waveforms of the remote control pulse signals into infrared coded signals for transmission.

In the above remote control signal transponder, the remote control signal is amplified by the front stage amplifier circuit and the final stage amplifier circuit, and the final stage amplifier circuit drives the infrared diode array to convert waveforms of the remote control pulse signals into infrared coded signals for transmission, so it can simulate the function of transmission for infrared remote control very well. Thus, the retransmission of infrared remote control signals between the electrical appliances can be realized with little hardware change in the electrical appliances.

The technical solution of the present invention may be best understood by reference to the following preferred implementations taken in conjunction with the accompanying drawings.

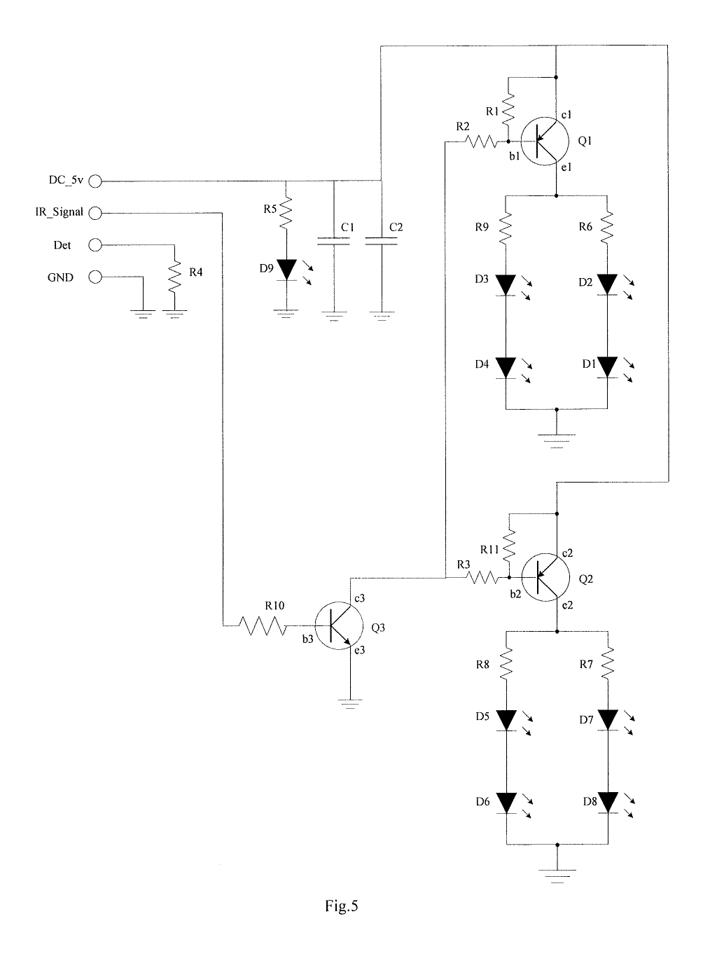

As shown in FIG. 4, the power input circuit and the signal input interface are connected with a 3.5 4 pin plug, and the power input circuit and the signal input interface are coupled to an interface for retransmission of infrared remote control signals in the intelligent television via the 3.5 4 pin plug.

The power input circuit accesses power supply via the interface for retransmission of infrared remote control signals, and the signal input interface accesses remote control pulse signals via the interface for retransmission of infrared remote control signals.

In the embodiment, a 3.5 4 pin plug may be used as an input connector. Four pins in the 3.5 4 pin plug are, respectively, grounding terminal (GND), pin for microcontroller control (DET), signal input terminal (IR_Signal) and power input terminal (DC). The DET can be set at high level or low level and configured to determine whether the remote control signal transponder exists (i.e., connected or disconnected), and the power supply is a 5V direct-current power supply.

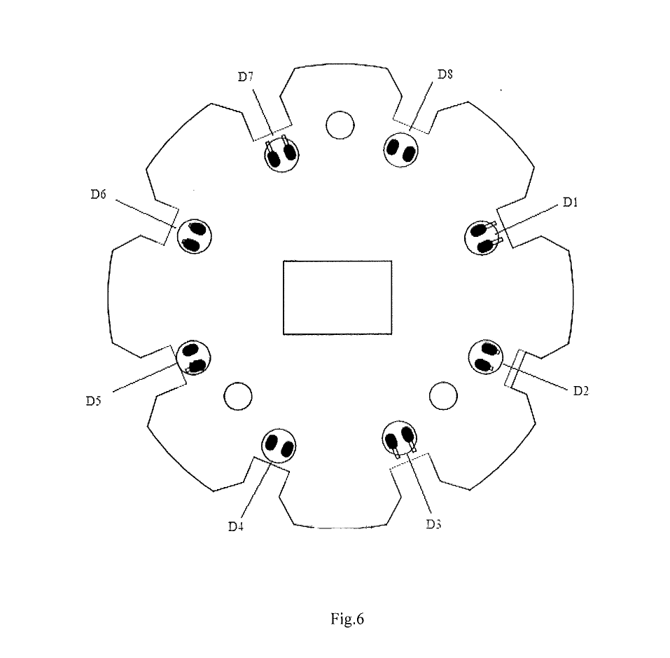

As shown in FIG. 5, the power input circuit includes a capacitor C1 and a capacitor C2 connected in parallel to the ground. The front stage amplifier circuit includes a NPN transistor Q3 and a resistance R10. The base of the transistor Q3 is coupled to the signal input interface via the resistance R10, and the emitter of the transistor Q3 is connected to the ground.

The final stage amplifier circuit includes a first drive circuit and a second drive circuit. The first drive circuit includes a PNP transistor Q1, a resistance R2 and a resistance R1 which is connected between the collector c1 and the base b1 of the transistor Q1. The base b1 of the transistor Q1 is coupled to the collector c3 of the transistor Q3 via the resistance R2. The second drive circuit includes a PNP transistor Q2, a resistance R3 and a resistance R11 which is connected between the collector c2 and the base b2 of the transistor Q2. The base b2 of the transistor Q2 is coupled to the collector c3 of the transistor Q3 via the resistance R3. The emitter e1 of the transistor Q1 and the emitter e2 of the transistor Q2 are coupled to the infrared diode array.

Further, the infrared diode array may include infrared diodes D1˜D8 and resistances R6˜R9.

The infrared diodes D1 and D2 and the resistance R6 are connected in series between the ground and the emitter e1 of the transistor Q1.

The infrared diodes D4 and D3 and the resistance R9 are connected in series between the ground and the emitter e1 of the transistor Q1.

The infrared diodes D6 and D5 and the resistance R8 are connected in series between the ground and the emitter e2 of the transistor Q2.

The infrared diodes D8 and D7 and the resistance R7 are connected in series between the ground and the emitter e2 of the transistor Q2.

In the embodiment, eight infrared diodes are used for ease of emitting the infrared remote control signals around. Because there may be a large current when the eight infrared diodes D1-D8 operate at the same time, two final stage amplifier transistors (transistors Q1 and Q2) are used to divide the infrared diodes D1˜D8 into two groups. In other embodiments, the number of the infrared diode can be increased or decreased based on actual demand in cases where demand can be anticipated.

In the embodiment, the capacitance of the capacitor C1 may be 100 NF, the parameter of the capacitor C2 may be 47 Uf/16 v, the resistance of each of the resistances R1 and R11 and may be 1 kΩ, the resistance of each of the resistances R2 and R3 may be 2 kΩ, the resistance of the resistance R10 may be 4.7 kΩ, and the resistance of each of the resistances R6-R9 may be 2.2Ω.

In a preferred embodiment, the remote control signal transponder may also include a resistance R5 and a diode D9 connected in series and to the power input terminal, wherein the diode D9 may be configured to be used as an indicator.

The pin for microcontroller control (Det) of the remote control signal transponder is coupled to the ground via the resistance R4, and the resistance of the resistance R4 may be 2.2Ω here.

As shown in FIG. 6, the remote control signal transponder according to the present invention may be provided with a circular housing, and the infrared diodes D1-D8 are evenly distributed around the circular housing.

With the arrangement of a plurality of the infrared diodes being evenly distributed around the circular housing, it can realize whole oriented transmission of the remote control signal, so that the retransmission of the remote control signal has better results.

In the above embodiments, the remote control signal transponder according to the present invention implements the signal amplification with a transistor of fast reaction rate and low loss. The remote control signal transponder can realize whole oriented transmission of the remote control signal with the arrangement of the circular housing and the plurality of the infrared diodes. As described above, the remote control signal transponder can be coupled to the interface for retransmission of infrared remote control signals in the intelligent television via the 3.5 4 pin plug, and it is better to retransmit the infrared remote control signals simulated by the intelligent television to the associated devices, such as set top box, video player and audio device.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is that:

1. A method for retransmission of infrared remote control signals, comprising:
acquiring key code values of a remote control of a second electrical appliance to be simulated and retransmitted by a first electrical appliance;
creating a key code value table of remote control pulse signals of the second electrical appliance according to the key code values, and storing the key code value table in a server;
downloading, by the first electrical appliance, the key code value table corresponding to the remote control of the second electrical appliance, from the server via a network; and
receiving, by the first electrical appliance, key codes that input from the remote control for remotely controlling the second electrical appliance, converting the received key codes into corresponding remote control pulse signals according to the key code value table, and retransmitting the remote control pulse signals to a signal receiver of the second electrical appliance.

2. The method of claim 1, wherein the second electrical appliance is an associated device used with the first electrical appliance; and
before the downloading, the method further comprises: providing an option of retransmitting the infrared remote control signals to the second electrical appliance in the operating system of the first electrical appliance to form a function interface of remote control which is added to the control program of the first electrical appliance.

3. The method of claim 1, wherein the first electrical appliance is an intelligent television, and the second electrical appliance is an associated device selected from the group consisting of set top box, video player and audio device.

4. The method of claim 3, wherein a main chip of the intelligent television is used to execute the stored software program to realize the simulation of the remote control pulse signals according to the key code values.

5. The method of claim 3, further comprises retransmitting the simulated remote control pulse signals to the signal receiver of the second electrical appliance via a remote control signal transponder coupled to an interface for retransmission of infrared remote control signals in the intelligent television.

6. A remote control signal transponder, comprising: a power input circuit, a signal input interface, a front stage amplifier circuit, a final stage amplifier circuit, and an infrared diode array, wherein
the power input circuit is configured to connect with the front stage amplifier circuit and the final stage amplifier circuit respectively; the signal input interface, the front stage amplifier circuit, the final stage amplifier circuit and the infrared diode array are configured to be connected in turn; and
the power input circuit is configured to supply power to the front stage amplifier circuit and the final stage amplifier circuit; remote control pulse signals are input to the signal input interface, and are pre-amplified by the front stage amplifier circuit; the infrared diode array is driven by the final stage amplifier circuit to convert waveforms of the remote control pulse signals into infrared coded signals for transmission.

7. The remote control signal transponder of claim 6, wherein the power input circuit and the signal input interface are connected with a 3.5 4 pin plug, and the power input circuit and the signal input interface are coupled to an interface for retransmission of infrared remote control signals in the intelligent television via the 3.5 4 pin plug;
the power input circuit accesses power supply via the interface for retransmission of infrared remote control signals, and the signal input interface accesses remote control pulse signals via the interface for retransmission of infrared remote control signals

8. The remote control signal transponder of claim 6, wherein the power input circuit comprises a capacitor C1 and a capacitor C2 connected in parallel and to the ground;
the front stage amplifier circuit comprises a NPN transistor Q3 and a resistance R10, wherein the base b3 of the transistor Q3 is coupled to the signal input interface via the resistance R10, and the emitter of the transistor Q3 is connected to the ground; and
the final stage amplifier circuit comprises a first drive circuit and a second drive circuit, wherein the first drive circuit may include a PNP transistor Q1, a resistance R2 and a resistance R1 which is connected between the collector c1 and the base b1 of the transistor Q1; the base b1 of the transistor Q1 is coupled to the collector c3 of the transistor Q3 via the resistance R2; the second drive circuit includes a PNP transistor Q2, a resistance R3 and a resistance R11 which is connected between the collector c2 and the base b2 of the transistor Q2; the base b2 of the transistor Q2 is coupled to the collector c3 of the transistor Q3 via the resistance R3, and the emitter e1 of the transistor Q1 and the emitter e2 of the transistor Q2 are coupled to the infrared diode array.

9. The remote control signal transponder of claim 8, wherein the infrared diode array comprises infrared diodes D1˜D8 and resistances R6˜R9;
the infrared diodes D1 and D2 and the resistance R6 are connected in series between the ground and the emitter e1 of the transistor Q1;
the infrared diodes D4 and D3 and the resistance R9 are connected in series between the ground and the emitter e1 of the transistor Q1;
the infrared diodes D6 and D5 and the resistance R8 are connected in series between the ground and the emitter e2 of the transistor Q2;
the infrared diodes D8 and D7 and the resistance R7 are connected in series between the ground and the emitter e2 of the transistor Q2.

10. The remote control signal transponder of claim 9, further comprises a circular housing, wherein the infrared diodes D1˜D8 are evenly distributed around the circular housing.
